(19) United States
(12) Patent Application Publication
(10) Pub. No.: US 2008/0230451 A1
(43) Pub. Date: Sep. 25, 2008

(54) Ion Exchange Cartridge

(75) Inventors: Ties Van Bommel, Eindhoven (NL); Zhenhua Yu, Singapore (SG); Mohankumar Valiyambath Krishnan, Singapore (SG); Swee Loon Michael Tang, Singapore (SG); Bas Jeroen Oosterman, Amersfoort (NL)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS N.V., Eindhoven (NL)

(21) Appl. No.: 11/817,833

(22) PCT Filed: Mar. 1, 2006
(86) PCT No.: PCT/IB06/50640

§ 371 Date: Sep. 5, 2007

(30) Foreign Application Priority Data
Mar. 7, 2005 (EP) 05101733.3

(51) Int. Cl. B01J 47/14; B01J 47/02

(52) U.S. Cl. 210/96.1; 210/282

(57) ABSTRACT

The invention provides an ion exchange cartridge (13), in particular for a domestic appliance that comprises between a water inlet (1A) and a water outlet (2A) a weak acid ion exchanger in the H⁺ form (5), followed by a strong acid ion exchanger in the Na⁺ form (7). This cartridge may be compact because it removes hard scale forming ions only. The cartridge may further comprise a first (16) and a second probe (17) to measure hard scale causing ions by a differential measurement of the conductivity of incoming water and water that has passed one or both ion exchangers. Herewith the appliance can be switched off when the cartridge is not functioning anymore, thus forcing a user to replace the cartridge, or to regenerate the ion exchangers before hard scale blocking of the appliance.

### FIELD OF THE INVENTION

The invention relates to an ion exchange cartridge for appliances that consume water while in use. Typical examples of such appliances are steam irons, coffee machines, espresso and cappuccino making machines, tea-kettles and facial saunas. The invention also relates to an appliance comprising the cartridge.

### BACKGROUND OF THE INVENTION

Generally these appliances are filled with tap water that contains hard scale causing ions like Ca²⁺, Mg²⁺, HCO₃⁻ and SO₄²⁻. These scale causing ions gradually forming scale deposits, which results in a decreased heat transfer and performance of the appliance and finally clog the heating element, channels and openings. Furthermore, scale built-up in e.g. a steam generator can result in blockage of the component openings since accumulated scale particles can be loosen from the steam generator channel surface. For this reason some existing appliances are provided with an ion exchange cartridge, comprising a water inlet and a water outlet, between a water reservoir and a heating element.

These known cartridges as e.g. described in U.S. Pat. No. 4,893,422, often comprise an ion exchange resin that changes colour when their water softening action decreases, thus warning an operator to timely replace the cartridge.

However, the existing cartridges require a large volume and are relatively expensive. Furthermore, the operator may easily observe the colour change too late or not at all, thus becoming faced with a failed appliance due to scale blockage.

### SUMMARY OF THE INVENTION

It is a first object of the present invention to provide a compact ion exchange cartridge.

According to the invention, the first object is achieved by the features of claim 1.

A cartridge according to the invention that comprises between the water inlet and the water outlet a weak acid ion exchanger in the H⁺ form, followed by a strong acid ion exchanger in the Na⁺ form is less expensive and more compact because it removes hard scale causing ions only. By removing hard scale causing ions only, less water treatment is necessary resulting in a smaller, less expensive cartridge that has an increased service life.

Typically water consists besides some SiO₂ particles and organic materials of sodium, calcium, magnesium cations and bicarbonate, chloride, sulphate and nitrate anions. The concentration of other ions (e.g. K⁺, NH₄⁺, Mn²⁺, Fe²⁺) is very low. The solubility of salt combinations containing cations and anions present in a typically water composition, expressed in grams per 100 ml are given in table 1.

TABLE 1

| | Ca | Mg | Na |
|---|---|---|---|
| CO₃ | 0.0018 | 0.0106 | 45.5 |
| OH | 0.077 | 0.004 | 347 |
| SO₄ | 0.1619 | 73.8 | 42.7 |
| Cl | 159 | 72.7 | 39.2 |
| NO₃ | 365 | 257 | 176 |

Calcium carbonate, magnesium carbonate, calcium hydroxide, magnesium hydroxide are poorly soluble and calcium sulphate is only slightly soluble in water. All other salt combinations are soluble in water. However, during water evaporation a hard scale of the least soluble combination of cations and anions is formed first. Therefore hardness-causing ions are primarily calcium, magnesium, bicarbonates and sulphates. Calcium and magnesium can react with bicarbonates to form calcium and magnesium hydroxides and/or carbonates. These ions form, during the evaporation of water an insoluble hard scale. Other salt combination will, after evaporation of water result in dissolvable soft scale like calcium chloride, calcium nitrate, magnesium sulphate, magnesium chloride, magnesium nitrate, sodium carbonate, sodium hydroxide, sodium sulphate, sodium chloride and sodium nitrate.

Completely treated deionised water is preferred in small domestic appliances, but can not be achieved economically, since using deionised water requires a large amount of resin in a prohibitive large cartridge and a corresponding high price for water treatment. It has been experimentally found that the use of non-treated water, e.g., hard water in electrical domestic appliances is not an option as well. Since steam channels are very small, they easily get clogged up with scale and blockage of the component openings can occur.

The inventors found that removal of only those ions which can cause insoluble hard scale (calcium, magnesium and bicarbonate ions) is a volume and cost reducing solution for the above-mentioned problem and that remaining soluble soft scale forming ions can be removed e.g. in small flow passages by a thermal shock scale self-cleaning method. During a self-clean a certain quantity of water flushes through the steam generator at a high flow rate.

### DETAILED DESCRIPTION OF THE INVENTION

The removal of hard scale causing ions only according to the invention is obtained by a cartridge comprising a water inlet and a water outlet, wherein the cartridge comprises between the water inlet and the water outlet a weak acid ion exchanger in the H⁺ form, followed by a strong acid ion exchanger in the Na⁺ form.

A Weak Acid Cation resin in the H⁺ form (WAC H⁺) is a resin with carboxylic functional groups, capable of removing bicarbonate bound ions according to the following reaction, wherein the affinity of the resin for several cations is given underneath:

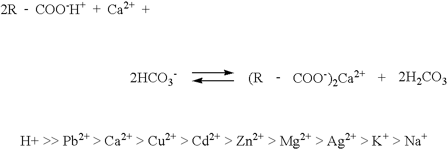

A WAC H⁺ therefore removes in particular the Ca and Mg ions which are related to the HCO₃ ions, hereinafter denoted as the temporary hardness.

The remaining Ca, Mg and minor amounts of other metals that precipitates with sulphate ions subsequently is removed by a Strong Acid Cation exchange resin (SAC Na⁺). This resin can also be in the K⁺ form. However the Na⁺ form is preferred since the affinity for Ca and Mg ions of a resin in the K⁺ form is lower than in the Na⁺ form. A Strong Acid Cation exchange resin in the H⁺ form (SAC H⁺) cannot be used, as the formation of corrosive acid by exchange with H⁺ ions should be avoided. A SAC resin bounds metal ions according to the reaction below, wherein the affinity for metals is given underneath:

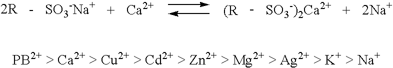

Weak and strong acid cation exchange resins are commercially available from e.g. Rohm and Haas, Dow, Sybron Chemicals, Purolite and Resin Tech.

A suitable WAC H⁺ resin is e.g. Amberlite IRC86 (Rohm and Haas) with a capacity of 4.2 eq/l. A suitable SAC Na⁺ resin is e.g. Amberjet 1200Na with a capacity of 2 eq/l. Both exchange resins are in the gel form. For a high end steam iron with a water consumption of about 60 l/year one cartridge of 118 ml (58 ml WAC and 60 ml SAC) would be in case of a 100% effective exchange sufficient to remove all hard scale causing ions during one year from tap water in accordance with the specifications of SHW. To produce the same amount of deionised water a cartridge with a volume of 728 ml (300 ml SAC H⁺ with a capacity of 2 eq/l and 428 ml of a strong basic type resin with a capacity of 1.4 eq/1) would be required.

Additionally the cartridge may comprise a third ion exchanger being a NO₃ form strong base anion exchange resin that removes SO₄ ions, to prevent the formation of insoluble CaSO₄. Although Ca ions could not be left after passing WAC H⁺ and a SAC Na⁺ resins, a NO₃ form strong base anion exchange resin can be used for extra safety in case that there is a small Ca ion leakage. Furthermore, NO₃ salts are very soluble (more soluble than NaSO₄ salts), thus easy to remove by steam and a self-clean.

It is a second object of the invention to provide a means that switches off the appliance when the cartridge should be replaced.

A known way to measure total amount of dissolved solids (TDS) is to measure the electric conductivity of the treated water as e.g. described in JP5513233. However, this common detection principle does not detect the removal of hard scale causing ions since the relationship between conductivity and TDS is greatly affected by the types of dissolved solids or salts present in the solution. This problem is solved by the inventors using an ion exchange cartridge, wherein a first and a second probe are present to measure hard scale causing ions by a difference measurement of the electric conductivity of incoming water and water that has passed one or both ion exchangers.

The first probe may be located at the water inlet of the cartridge and measures the conductivity of the water to be treated. The second probe may be located at the water outlet of the cartridge, but is preferably located just after the WAC H⁺ resin and measures the conductivity of the water from which the temporary hardness is removed. The difference between the conductivity measured by both probes should be constant as long as temporary hardness is removed by the WAC H⁺ exchanger. If an increase in conductivity read by the second probe and a resulted decrease in conductivity difference between the first and the second probe is detected, the lifetime of the weak acid cation exchange resin is ending and a detection system may switch off the appliance in order to force the operator to replace the cartridge.

To avoid an unexpected switching off of the appliance during its use, the second probe is placed after the weak ion exchanger in the H⁺ form, followed by a further amount of weak ion exchanger in the H⁺ form before the strong acid ion exchanger.

This allows the operator to finish the use of the appliance without the risk of hard scale formation. Another advantage is that a higher decrease in conductivity difference is allowed before the system is switched off, without having hard scale causing ions present in the output of the cartridge.

After switching of the appliance, a special electronic circuit or software programme can shut down the appliance, or at least a water supply pump until a new cartridge is inserted, or the resin in the cartridge has been regenerated. It is preferred that the appliance according to the invention comprises a detection system that switches off the appliance at a preset decrease of a conductivity difference measured between the first and the second probe after finishing the use of the appliance, to force an operator to replace the cartridge.

If the operator is using deionised water, the first probe will measure a low conductivity and no action will be taken.

The invention is further related to an appliance, and in particular a steam iron, comprising a cartridge of the invention. It is to be noted that an appliance particularly an electrical appliance may comprise a steam iron, a coffee machine, an espresso and cappuccino making machine, a tea-kettle or a facial sauna. It is preferred that the appliance according to the invention comprises a detection system that switches off the appliance after use of the appliance, for instance to force an operator to replace the cartridge, or to regenerate the ion exchangers.

### SHORT DESCRIPTION OF THE FIGURES

FIG. 1 shows a cartridge according to the invention.

FIG. 2 shows a steam iron comprising the cartridge of the invention.

FIGS. 3 and 4 show steam generators used in the steam iron of FIG. 2.

### DETAILED DESCRIPTION OF THE FIGURES

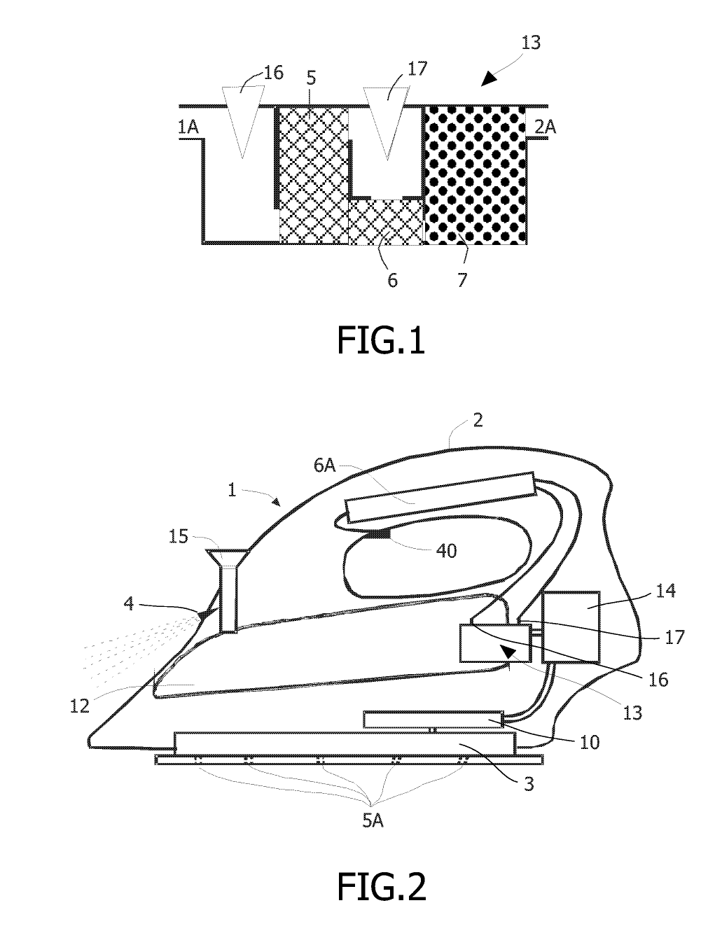

FIG. 1 shows an ion exchange cartridge according to the invention comprising between the water inlet 1A and the water outlet 2A a weak acid ion exchanger in the H⁺ form 5, followed by a strong acid ion exchanger in the Na⁺ form 7 wherein a first probe 16 and a second probe 17 are present, the second probe 17 being placed after the weak ion exchanger in the H⁺ form 5, followed by a further amount of weak ion exchanger in the H⁺ form 6 before the strong acid ion exchanger 7.

FIG. 2 shows a steam iron 1 having a housing 2 with a soleplate 3 at the bottom side of the housing. A water reservoir 12, a water reservoir inlet 15, an electric pump 14, a steam generator 10, and control means 6A are accommodated inside the housing. User-operable control buttons 40 are provided on the housing 2 to control several function of the device. The soleplate 3 of the iron is provided with steam discharge openings 5A. Discharge opening 4, is for the delivery of mist steam, and discharge openings 5A are for the delivery of superheated steam. The ion exchange cartridge according to the invention 13 is placed between the water reservoir 12 and the pump 14. In this embodiment the water inlet and water outlet are positioned at the non-visible backside of the cartridge, to allow the cartridge to be replaced via an opening at the left side of the iron. A first probe 16 and a second probe 17 are positioned at respectively the water inlet and the water outlet of the cartridge.

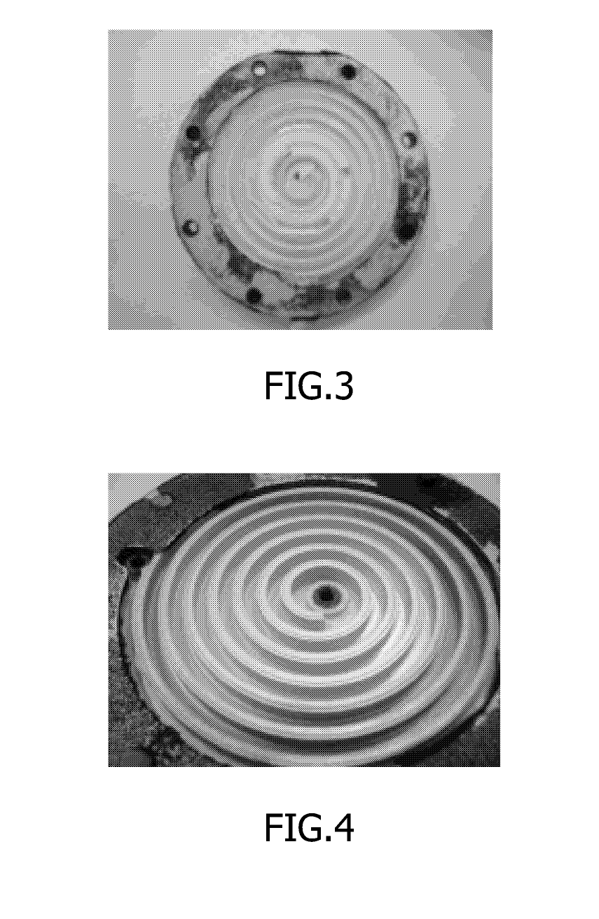

FIGS. 3 and 4 are steam generators after subjected to respectively Comparative Experiment A and Example 1.

### EXAMPLES AND COMPARATIVE EXPERIMENTS

All examples and comparative experiments were carried out with standard hard water (SHW) of the composition as given in table 2, which is generally used as model water in testing of domestic appliances.

TABLE 2

| | Concentration | | Concentration |
|---|---|---|---|
| Cations | mmol/l | anions | mmol/l |
| Ca²⁺ | 2.23 | Cl⁻ | 4.46 |
| Mg²⁺ | 0.77 | SO₄²⁻ | 0.77 |
| Na⁺ | 4.00 | HCO₃⁻ | 4.00 |

The examples and comparative experiments are carried out using a steam generator with a volume of 8.8 cm³, followed by steam channels and nozzles. Scaling tests with simulated user operation condition have been done using a steam program.

The steam program consists of 15 seconds steam with a temperature around 200° C. and a flow rate of 40 grams per minute followed by 10 seconds rest. The test is stopped after running 11 litre of water (18 hours). A self-clean may be used in order to dissolve dissolvable salts and/or rinsing them away. In a self-clean 0.5 litre of water is flushed through the steam generator with a flow rate of 100 grams per minute. During the self-clean, the temperature of the steam generator decreases to a temperature in the range of 60-40° C.

### Comparative Example A

11 Litre SHW were passed through the steam generator of a steam iron, further comprising a divider, a deviator, tubes and nozzles, in a steam program followed by a self-clean. The steam generator is clogged (see FIG. 3) and the nozzles are blocked. A thin layer of scale can be found covering the complete steam channel. A decrease in steam generation at the nozzles is already observed after running a few litres of SHW. Complete blockage occurred during the self-clean since scale particles are loosed from the steam generator and blocked the orifice of the nozzles. After 11 litre SHW, loose scale particles have been found in the nozzles, tubes, divider and deviator.

### Comparative Experiment B

A scaling test was carried out with 33 litre of SHW that has passed through a cartridge comprising 58 ml WAC H⁺ exchange resin (Amberlite IRC86). The test was carried out by a three-fold program each time followed by a self-clean. A small amount of scale was built up in the steam generator. Repeating this test with a cartridge comprising 300 ml WAC H⁺ exchange resin caused scale in the steam generator.

### Example 1

A scaling test was carried out with water that has passed through a cartridge comprising 75 ml WAC H⁺ exchange resin (Amberlite IRC86), followed by an amount of 75 ml of a SAC Na⁺ exchange resin (Amberjet 1200 Na) with 50 litre of SHW. The test was carried out by the steam program each time followed by a self-clean. No scale was found in the channel part of the steam generator (FIG. 4). There was no blockage of the nozzles. It can be concluded that soluble soft scale was removed with steam and/or self-clean.

### Example 2

A cartridge as shown in FIG. 1, provided with a conductivity probe 3 at the water inlet 1 and a second probe 4 placed after 60 ml of the WAC H⁺ resin 5, followed by another 15 ml WAC H⁺ resin 6 and a compartment with 75 ml SAC Na⁺ resin 7 was flushed with SHW and replaced after a 20% decrease of the conductivity difference measured by the two probes. After 154 litre of SHW and 2 replacements of the cartridge there was no blockage of the nozzles. Even without using a self-clean, no soft-scale was formed in the steam generator, which means that soft-scale was removed from the steam generator by the steam itself.

1. Ion exchange cartridge comprising a water inlet and a water outlet, wherein the cartridge comprises, between the water inlet and the water outlet, a weak acid ion exchanger in the H⁺ form, followed by a strong acid ion exchanger in the Na⁺ form and/or K⁺ form.

2. Cartridge according to claim 1, wherein the strong acid ion exchanger is in the Na⁺ form.

3. Cartridge according to claim 1 or 2, wherein a first and a second probe are present to measure hard scale causing ions by a differential measurement of the conductivity of incoming water and water that has passed one or both ion exchangers.

4. Cartridge according to claim 1, 2 or 3, wherein the first probe is placed before and the second probe is placed after the weak ion exchanger in the H⁺ form.

5. Cartridge according to claim 4, wherein the second probe is followed by a further amount of weak ion exchanger in the H⁺ form before the strong acid ion exchanger.

6. Cartridge according to any one of the claims 1 to 5, wherein the strong acid ion exchanger is followed by a third ion exchanger being a NO₃ form strong base anion exchange resin.

7. Appliance, in particular a steam iron, comprising a cartridge according to any one of the preceding claims.

8. Appliance according to claim 7, comprising a detection system having two detection points corresponding to the first and second probes, which system switches off the appliance at a preset decrease of a conductivity difference measured between the first and the second probe.

9. Appliance according to claim 8, wherein the detection system is provided with an electronic device that switches off the appliance at the preset decrease after finishing the use of the appliance.
